(19) United States
(12) Patent Application Publication
(10) Pub. No.: US 2023/0311209 A1
(43) Pub. Date: Oct. 5, 2023

(54) POWDER METAL MATERIAL FOR ADDITIVE MANUFACTURING USING 3D PRINTER WHICH IS ALUMINUM ALLOY AND ADDITIVE MANUFACTURING METHOD

(71) Applicant: HONDA MOTOR CO., LTD., Tokyo (JP)

(72) Inventors: Hiroyuki WATANABE, Saitama (JP); Kazuo KIKAWA, Saitama (JP)

(73) Assignee: HONDA MOTOR CO., LTD., Tokyo (JP)

(21) Appl. No.: 18/123,667

(22) Filed: Mar. 20, 2023

(30) Foreign Application Priority Data
Mar. 31, 2022 (JP) 2022-060260

(51) Int. Cl. B22F 10/20

(52) U.S. Cl. CPC B22F 10/20; B33Y 10/00

(57) ABSTRACT

A powder metal material in order to being used in additive manufacturing, in which the powder metal material is an aluminum alloy, and the aluminum alloy contains at least one selected from the group consisting of Ti, Zr, and P, and the additive manufacturing is additive manufacturing using a 3D printer.

### CROSS-REFERENCE TO RELATED APPLICATION

This application is based on and claims priority under 35 USC 119 from Japanese Patent Application No. 2022-060260 filed on Mar. 31, 2022.

### TECHNICAL FIELD

The present invention relates to a powder metal material for additive manufacturing using a 3D printer, which is an aluminum alloy, and an additive manufacturing method.

### BACKGROUND ART

Aluminum alloys are used, for example, in applications requiring weight reduction, such as vehicles and aircraft.

An additive manufacturing method using an aluminum alloy powder is known (see, for example, JP2021-531398A, JP2021-152189A, and JP6393008B).

### SUMMARY OF INVENTION

In the related art, crystal grain refinement for increasing a strength of an aluminum alloy is performed by adding a refining agent, as described in JP2021-531398A, for example.

However, in an aluminum alloy in the related art, it is difficult to reduce the crystal grain size to 30 μm or less, and when Cu, Zn, Ni, etc., which are highly effective in increasing the strength, are added, there is a problem that the grain boundary stress becomes high, cracks occur, and manufacturing becomes difficult. Therefore, there is a demand for further crystal grain refinement.

The present invention provides a powder metal material for additive manufacturing using a 3D printer, which is an aluminum alloy which enables crystal grain refinement and from which a high strength manufactured object can be obtained, and an additive manufacturing method using the above powder metal material.

A powder metal material according to the present invention is a powder metal material for additive manufacturing using a 3D printer, which is an aluminum alloy containing: at least one of Ti, Zr, and P.

According to the present invention, it is possible to provide a powder metal material for additive manufacturing using a 3D printer, which is an aluminum alloy which enables crystal grain refinement and from which a high strength manufactured object can be obtained, and an additive manufacturing method using the above powder metal material.

### DETAILED DESCRIPTION OF THE INVENTION

Hereinafter, embodiments for carrying out the present invention will be described in detail.

### [Powder Metal Material]

A powder metal material according to the present invention is a powder metal material for additive manufacturing using a 3D printer, which is an aluminum alloy containing: at least one of Ti, Zr, and P.

With the powder metal material according to the present invention, crystal grain refinement can be achieved, and a high strength manufactured object can be obtained.

The aluminum alloy of the powder metal material according to the present invention contains at least one of Ti, Zr, and P, and generates nuclei that are highly compatible with an Al matrix phase, such as Al₃Ti, Al₃Zr, and AlP, in a solidification process during additive manufacturing using a 3D printer, and promotes the refinement of the matrix phase, which increases the strength by the crystal grain refinement. Since the additive manufacturing using a 3D printer involves a cooling rate higher than that of casting, it is thought that the crystal grain refinement can be achieved. In addition, since a grain boundary stress can be dispersed to prevent the occurrence of cracks, an element for further increasing the strength (for example, Cu, Zn, or Ni) can be added.

The aluminum alloy of the powder metal material according to the present invention preferably contains at least one of Ti and Zr, and more preferably contains Ti.

In addition, the aluminum alloy of the powder metal material according to the present invention also preferably contains Ti and Zr.

The aluminum alloy of the powder metal material according to the present invention preferably further contains at least one of Si, Mg, Zn, Fe, Ni, and Mn. A manufacturing property can be improved by containing at least one of Si, Mg, Zn, Fe, Ni, and Mn in the aluminum alloy.

The aluminum alloy more preferably contains at least one of Si, Mg, Zn, Fe, and Mn.

It is preferable that the aluminum alloy of the powder metal material according to the present invention contains, in terms of mass %,
Ti: 0.5% to 3.0%,
Zr: 3.0% or less,
P: 3.0% or less,
Si: 3.0% to 20.0%,
Cu: 0.1% to 10.0%,
Mn: 0.1% to 1.0%,
Mg: 0.1% to 3.0%,
Ni: 5.0% or less,
Cr: 2.0% or less,
Zn: 0.05% to 3.0%, and
Fe: 0.5% to 5.0%.

Note that unless otherwise specified, the content of each alloying element is a mass-based value based on 100% of the entire aluminum alloy.

Since the powder metal material according to the present invention may contain the above impurity elements in addition to Al, which is the main constituent element of the aluminum alloy, it is preferred from the viewpoint that secondary ingots containing many impurities such as Fe and Zn or recycled materials containing many impurities can be used as raw materials and from the viewpoint of reducing carbon dioxide emissions during production, saving resources, and reducing environmental load. In addition, it is possible to utilize the regenerated ingots and to refine the impurity elements in the regenerated ingots, thereby contributing to increasing the strength.

The aluminum alloy of the powder metal material according to the present invention preferably has the balance being Al and inevitable impurities in the above chemical composition.

In the aluminum alloy of the powder metal material according to the present invention, a content of Al is preferably 60 mass % or more, more preferably 70 mass % or more, and still more preferably 80 mass % or more.

The inevitable impurities are components that can be inevitably mixed from raw materials or the environment during the production of the aluminum alloy in the present invention, and examples thereof include Na, Sb, Sr, and Li. A content of the inevitable impurities is usually 0.1 mass % or less.

A content of Ti in the aluminum alloy is preferably 0.5 mass % to 3.0 mass %, more preferably 0.8 mass % to 2.5 mass %, and still more preferably 1.0 mass % to 2.0 mass %.

A content of Zr in the aluminum alloy is preferably 3.0 mass % or less, more preferably 2.5 mass % or less, and still more preferably 2.0 mass % or less. The lower limit of the content of Zr in the aluminum alloy is not particularly limited, and may be 0 mass % or more. The aluminum alloy may not contain Zr. When the aluminum alloy contains Zr, the content of Zr may be 0.7 mass % to 2.5 mass % or 1.0 mass % to 2.0 mass %.

A content of P in the aluminum alloy is preferably 3.0 mass % or less, more preferably 2.0 mass % or less, and still more preferably 1.0 mass % or less. The lower limit of the content of P in the aluminum alloy is not particularly limited, and may be 0 mass % or more. The aluminum alloy may not contain P. When the aluminum alloy contains P, the content of P may be 0.1 mass % to 2.0 mass %.

A content of Si in the aluminum alloy is preferably 3.0 mass % to 20.0 mass %, more preferably 5.0 mass % to 17.0 mass %, still more preferably 7.0 mass % to 16.0 mass %, and particularly preferably 8.0 mass % to 15.0 mass %.

When the aluminum alloy contains Si, the manufacturing property can be improved.

A content of Cu in the aluminum alloy is preferably 0.1 mass % to 10.0 mass %, more preferably 0.5 mass % to 8.0 mass %, still more preferably 1.0 mass % to 7.0 mass %, and particularly preferably 3.0 mass % to 5.0 mass %.

A content of Mn in the aluminum alloy is preferably 0.1 mass % to 1.0 mass %, more preferably 0.2 mass % to 0.8 mass %, and still more preferably 0.3 mass % to 0.5 mass %.

A content of Mg in the aluminum alloy is preferably 0.1 mass % to 3.0 mass %, more preferably 0.2 mass % to 2.0 mass %, still more preferably 0.3 mass % to 1.0 mass %, and particularly preferably 0.4 mass % to 0.8 mass %.

A content of Ni in the aluminum alloy is preferably 5.0 mass % or less, more preferably 3.0 mass % or less, still more preferably 2.0 mass % or less, and particularly preferably 1.5 mass % or less. The lower limit of the content of Ni in the aluminum alloy is not particularly limited, and may be 0 mass % or more. The aluminum alloy may not contain Ni.

A content of Cr in the aluminum alloy is preferably 2.0 mass % or less, more preferably 0.5 mass % or less, still more preferably 0.3 mass % or less, and particularly preferably 0.1 mass % or less. The lower limit of the content of Cr in the aluminum alloy is not particularly limited, and may be 0 mass % or more. The aluminum alloy may not contain Cr.

A content of Zn in the aluminum alloy is preferably 0.05 mass % to 3.0 mass %, more preferably 0.1 mass % to 2.0 mass %, and still more preferably 0.2 mass % to 1.0 mass %.

A content of Fe in the aluminum alloy is preferably 0.5 mass % to 5.0 mass %, more preferably 0.7 mass % to 4.0 mass %, and still more preferably 1.0 mass % to 3.0 mass %.

The particle size of the powder metal material according to the present invention is not particularly limited. Known particle sizes suitable for additive manufacturing using a 3D printer (for example, 10 μm to 200 μm of volume average particle size (D₅₀) measured with a laser diffraction particle size distribution measuring device) can be used.

A method for producing the powder metal material according to the present invention is not particularly limited, and known methods (for example, a gas atomization method, a plasma atomization method, and a centrifugal atomization method) can be used.

### [Additive Manufacturing Method]

An additive manufacturing method according to the present invention is manufacturing using a 3D printer by using the above powder metal material.

The additive manufacturing method according to the present invention is additive manufacturing using a 3D printer, and a cooling rate after the powder metal material is melted by laser or electron beam irradiation is high. Therefore, the crystal grain can be refined.

In the additive manufacturing method according to the present invention, the cooling rate after the powder metal material is melted is preferably 10³° C./sec or more, and more preferably 10⁴° C./sec or more. When the cooling rate is 10³° C./sec or more, the crystal grain refinement can be effectively performed.

As the 3D printer, a known one can be used.

The additive manufacturing method is not particularly limited, and for example, a powder bed fusion method and a direct energy deposition method are preferred.

### [Manufactured Object]

A manufactured object obtained by performing additive manufacturing using a 3D printer on the powder metal material according to present invention has an average grain size of crystal grains of preferably 30 μm or less, more preferably 20 μm or less, and still more preferably 10 μm or less.

The manufactured object produced by the additive manufacturing method according to the present invention has an excellent strength and thus can be used for various purposes such as automobile parts.

### EXAMPLES

Hereinafter, the present invention will be described more specifically by way of Examples and Comparative Examples, but the present invention is not limited thereto.

Aluminum alloy powders (average grain size: 45 μm) having compositions shown in Table 1 below were prepared. In Table 1, “Bal” indicates “balance”.

The aluminum alloy powders in Examples 1 to 3 were prepared by a gas atomization method.

The aluminum alloy powder in Comparative Example 1 was prepared by using an aluminum alloy commercially available as a general material.

The aluminum alloy powders in Examples and Comparative Examples shown in Table 1 were subjected to additive manufacturing using a 3D printer (EOS M290) to produce manufactured objects.

The 3D printer used had a cooling rate of 10⁵° C./sec other the aluminum alloy powder was melted.

### <Measurement of Crystal Grain Size>

A microstructure of the obtained manufactured object was observed by an EBSD method (scanning electron microscope SU6600 manufactured by Hitachi High-Tech Corporation, and symmetry S2 manufactured by OXFORD Instruments) to determine the average grain size of the crystal grains.

The average grain size of the crystal grains in Examples 1 to 3 was 5 μm.

The average grain size of the crystal grains in Comparative Example 1 was 70 μm.

As can be seen from the results, the crystal grains of the aluminum alloy powders in Examples 1 to 3 can be refined as compared with the aluminum alloy powder in Comparative Example 1.

### <Measurement of Strength>

A JIS No. 4 test piece was prepared from the obtained manufactured object, and a tensile test was performed at 23° C. using a universal testing machine (Autograph manufactured by Shimadzu Corporation). A crosshead speed was 0.1 mm/min. A stress when the test piece broke was taken as the tensile strength (MPa). The results are shown in the “Strength (MPa)” column in Table 1.

TABLE 1

| | | | | | | | | | | | | Strength |
|---|---|---|---|---|---|---|---|---|---|---|---|---|
| mass % | Si | Cu | Mn | Mg | Zn | Fe | Ni | Cr | Zr | Ti | Al | (MPa) |
| Comparative | 6.9 | 0.05 | 0.1 | 0.3 | 0.01 | 0.1 | — | — | — | 0.05 | Bal | 300 |
| Example 1 | | | | | | | | | | | | |
| (AC4CH) | | | | | | | | | | | | |
| Example 1 | 7.0 | 0.1 | 0.3 | 0.4 | 0.5 | 1.0 | — | — | 1.8 | 1.3 | Bal | 380 |
| Example 2 | 12.2 | 3.8 | 0.4 | 0.4 | 0.8 | 1.0 | — | — | 1.3 | 1.0 | Bal | 420 |
| Example 3 | 12.2 | 3.8 | 0.4 | 0.4 | 0.8 | 1.0 | — | — | — | 1.0 | Bal | 430 |

As can be seen from Table 1 that with the aluminum alloy powders in Examples 1 to 3, a manufactured object having a strength higher than that produced using the aluminum alloy powder in Comparative Example 1 can be produced.

Although the embodiment of the present invention has been described above, the present invention is not limited to the above embodiment, and modifications, improvements, or the like can be made as appropriate.

In the present description, at least the following matters are described.

(1) A powder metal material for additive manufacturing using a 3D printer, which is an aluminum alloy containing: at least one of Ti, Zr, and P.

According to (1), the strength can be increased by crystal grain refinement in additive manufacturing using a 3D printer. In addition, since a grain boundary stress can be dispersed to prevent the occurrence of cracks, an element (for example, Cu, Zn, or Ni) can be added to further increase the strength.

(2) The powder metal material according to (1), in which the aluminum alloy further contains at least one of Si, Mg, Zn, Fe, Ni, and Mn.

According to (2), the manufacturing property can be improved.

(3) The powder metal material according to (1) or (2), in which the aluminum alloy contains
in terms of mass %,
Ti: 0.5% to 3.0%,
Zr: 3.0% or less,
P: 3.0% or less,
Si: 3.0% to 20.0%,
Cu: 0.1% to 10.0%,
Mn: 0.1% to 1.0%,
Mg: 0.1% to 3.0%,
Ni: 5.0% or less,
Cr: 2.0% or less,
Zn: 0.05% to 3.0%, and
Fe: 0.5% to 5.0%.

According to (3), it makes contribution from the viewpoint that secondary ingots containing many such as Fe and Zn, or recycled materials containing many impurities can be used as raw materials and from the viewpoint of reducing carbon dioxide emissions during production, saving resources, and reducing environmental load. in addition, it is possible to utilize the regenerated ingots and to refine the impurity elements in the regenerated ingots, thereby contributing to increasing the strength.

(4) An additive manufacturing method including: performing manufacturing using a 3D printer by using the powder metal material according to any one of (1) to (3).

According to (4), the crystal grains can be refined.

(5) The additive manufacturing method according to (4), in which a cooling rate after the powder metal material is melted is 10³° C./sec or more.

According to (5), the crystal grains can be effectively refined.

What is claimed is:

1. A powder metal material for additive manufacturing using a 3D printer, which is an aluminum alloy comprising:
at least one of Ti, Zr, and P.

2. The powder metal material according to claim 1, wherein the aluminum alloy further contains at least one of Si, Mg, Zn, Fe, Ni, and Mn.

3. The powder metal material according to claim 1, wherein
the aluminum alloy contains
0.5 to 3.0 mass % of Ti,
3.0 mass % or less of Zr,
3.0 mass % or less of P,
3.0 to 20.0 mass % of Si,
0.1 to 10.0 mass % of Cu,
0.1 to 1.0 mass % of Mn,
0.1 to 3.0 mass % of Mg,
5.0 mass % or less of Ni,
2.0 mass % or less of Cr,
0.05 to 3.0 mass % of Zn, and
0.5 to 5.0 mass % of Fe.

4. The powder metal material according to claim 2, wherein
the aluminum alloy contains
0.5 to 3.0 mass % of Ti,
3.0 mass % or less of Zr,
3.0 mass % or less of P,
3.0 to 20.0 mass % of Si,
0.1 to 10.0 mass % of Cu,
0.1 to 1.0 mass % of Mn,
0.1 to 3.0 mass % of Mg,
5.0 mass % or less of Ni,
2.0 mass % or less of Cr,
0.05 to 3.0 mass % of Zn, and
0.5 to 5.0 mass % of Fe.

5. An additive manufacturing method comprising:
performing manufacturing using a 3D printer by using the powder metal material according to claim 1.

6. An additive manufacturing method comprising:
performing manufacturing using a 3D printer by using the powder metal material according to claim 2.

7. An additive manufacturing method comprising:
performing manufacturing using a 3D printer by using the powder metal material according to claim 3.

8. An additive manufacturing method comprising:
performing manufacturing using a 3D printer by using the powder metal material according to claim 4.

9. The additive manufacturing method according to claim 5, wherein a cooling rate after the powder metal material is melted is 10³° C./sec or more.

10. The additive manufacturing method according to claim 6, wherein a cooling rate after the powder metal material is melted is 10³° C./sec or more.

11. The additive manufacturing method according to claim 7, wherein a cooling rate after the powder metal material is melted is 10³° C./sec or more.

12. The additive manufacturing method according to claim 8, wherein a cooling rate after the powder metal material is melted is 10³° C./sec or more.
